(19) United States
(12) Patent Application Publication
(10) Pub. No.: US 2013/0242227 A1
(43) Pub. Date: Sep. 19, 2013

(54) LCD Device

(71) Applicant: Yanxue Zhang, Shenzhen (CN)

(72) Inventor: Yanxue Zhang, Shenzhen (CN)

(21) Appl. No.: 13/510,971

(22) PCT Filed: Apr. 27, 2012
(86) PCT No.: PCT/CN2012/074833

§ 371 Date: May 21, 2012

(30) Foreign Application Priority Data
Mar. 15, 2012 (CN) 201210068995.6

(51) Int. Cl. G02F 1/1333; G02F 1/1339

(52) U.S. Cl. 349/60

(57) ABSTRACT

The invention provides an LCD device, comprising a front frame, a rubber frame, and a backplane which are mutually matched and fixed in sequence from outside to inside; an LCD panel is clamped between the front frame and the rubber frame, the front frame is made of insulation material, and the surface of the front frame is provided with a conducting film; the backplane is made of conducting material, a conducting component(s) is connected between the conducting film and the backplane, and the conducting film is electrically connected with the backplane by the conducting component. In the invention, because the front frame is made of insulation material, the production cost of the front frame can be reduced, and light weight can be achieved. The insulation material can be material such as plastic material, etc. to achieve various raw materials. In addition, the surface of the front frame made of plastic material is covered with the conducting film, and then the conducting film is connected with the backplane made of conducting material by the conducting components; thus, the static electricity generated by the COF is discharged onto the backplane by the conducting film, and the COF and IC are prevented from being broken down by static electricity.

### TECHNICAL FIELD

The invention relates to the field of liquid crystal displays (LCDs), and more particularly to an LCD device.

### BACKGROUND

An LCD device includes a backlight module, and an LCD panel; the backlight module is fixed to the LCD panel via a front frame. All the frequently-used front frames of conventional backlight modules in mass production are made of metal material.

Pat. Pub. No. CN201690669U, published on Dec. 29, 2010, discloses an anti-static component for a display. The component includes a front frame for the display, and an LCD screen; a spacing bar(s) capable of conducting electricity is arranged between the front frame and the LCD screen, to achieve the aim of discharging static electricity, thereby reducing the influence of the failure of an electrostatic impedor on the image.

Pat. Pub. No. US2007/0070263A1, published on Mar. 29, 2007, discloses a display device. The device includes a conducting film; the conducting film is arranged between a slider for clamping an LCD panel and a conducting polarizer; thus, static electricity is discharged onto the front frame thought the conducting film and the slider, and the display quality is effectively prevented from being reduced.

Both the aforementioned two technologies employ metal front frames, resulting in the following problems: first, the cost of metal material is much higher than that of plastic material; second, the metal material is difficult to achieve light weight design; third, there is a higher risk of cost rise of raw material because of single material; when plastic material is applied to the front frame for fixing, the flexible printed circuit board (COF) and integrated circuit (IC) may be broken by static electricity because plastic material is insulated, resulting in the failure of the function of the module.

### SUMMARY

In view of the above-described technical problems, the aim of the invention is to provide an LCD device with the advantages of low cost, light weight and anti-static function.

The aim of the invention is achieved by the following technical scheme.

An LCD device comprises a front frame, a rubber frame, and a backplane which are mutually matched and fixed in sequence from outside to inside; an LCD panel is clamped between the front frame and the rubber frame, the front frame is made of insulation material, and the surface of the front frame is provided with a conducting film; the backplane is made of conducting material, a conducting component(s) is connected between the conducting film and the backplane, and the conducting film is electrically connected with the backplane by the conducting component.

Preferably, only one side of the front frame facing the LCD panel is covered with the conducting film. Among all the components which are in contact with the front frame, only the LCD panel has the anti-static requirement. Therefore, rightly covering the side facing the LCD panel with the conducting film can further reduce cost.

Preferably, the conducting component is a conducting spacer made of flexible material; one end of the conducting spacer is butted with the front frame, and the other end is butted with the backplane. Flexible material has certain elasticity; thus, the thickness of the conducting spacer can be slightly more than the distance between the front frame and the backplane. Therefore, the conducting spacer is extruded during assembly, and then is in close contact with the front frame and the backplane to achieve reliable electrical connection between the front frame and the backplane.

Preferably, the LCD device comprises a rubber frame arranged between the front frame and the backplane; one side of the rubber frame facing the front frame is provided with a through hole(s), and the conducting component penetrates through the through hole and then respectively connected with the front frame and the backplane. For an LCD device with a rubber frame, because the rubber frame is arranged across the front frame and the backplane, the conducting component penetrates through the through hole and then is respectively connected with the front frame and the backplane by an opening receiving mode; therefore, the connecting distance is minimized, thereby favoring simplification of design and assembly, and reducing the material cost of conducting components.

Preferably, the backplane is bent at one end corresponding to the conducting component to form a connecting surface in the position near the through hole, and the conducting component penetrates through the through hole and then is respectively connected with the front frame and the connecting surface of the backplane. A certain distance is reserved between the backplane and the side of the rubber frame with the through hole, and the backplane is close to the through hole of the rubber frame as far as possible after being bent; thus, the distance between the backplane and the front frame is shortened, the use of the material of the conducting components is reduced, and the material cost is reduced.

Preferably, the LCD device comprises a rubber frame arranged between the front frame and the backplane; one side of the rubber frame facing the front frame is provided with a through hole(s), the backplane is bent at one end corresponding to the conducting component to form a connecting surface in the position near the through hole, and the connecting surface of the backplane penetrates through the through hole and then is connected with the conducting component. This is another electric connection mode of the bent backplane.

Preferably, the conducting components are symmetrically distributed. The conducting components have the function of bearing; thus, symmetrical distribution favors average stress, and increases the bearing capacity.

Preferably, the conducting film is of a metal film. This is a specific conducting film form.

Preferably, the insulation material is of a plastic material. This is a specific insulation material form.

In the invention, because the front frame is made of insulation material, the production cost of the front frame can be reduced, and light weight can be achieved. The insulation material can be material such as plastic material, etc. to achieve various raw materials. In addition, the surface of the front frame made of plastic material is covered by the conducting film, and then the conducting film is connected with the backplane made of conducting material by the conducting components; thus, the static electricity generated by the COF is discharged onto the backplane by the conducting film, and the COF and IC are prevented from being broken down by static electricity.

### BRIEF DESCRIPTION OF FIGURES

FIG. 1 is a structure diagram of the invention;

FIG. 2 is a schematic diagram of a front frame of the invention;

FIG. 3 is schematic diagram of a conducting film matched with a conducting spacer of the invention; and

FIG. 4 is a schematic diagram of a through hole of a rubber frame matched with a conducting spacer of the invention.

Legends: 100. front frame; 200. metal film; 300. LCD panel; 400. conducting spacer; 500. rubber frame; 510. through hole; 600. backplane; 610. connecting surface; 700. COF

### DETAILED DESCRIPTION

The invention will further be described in detail in accordance with the figures and the preferable examples.

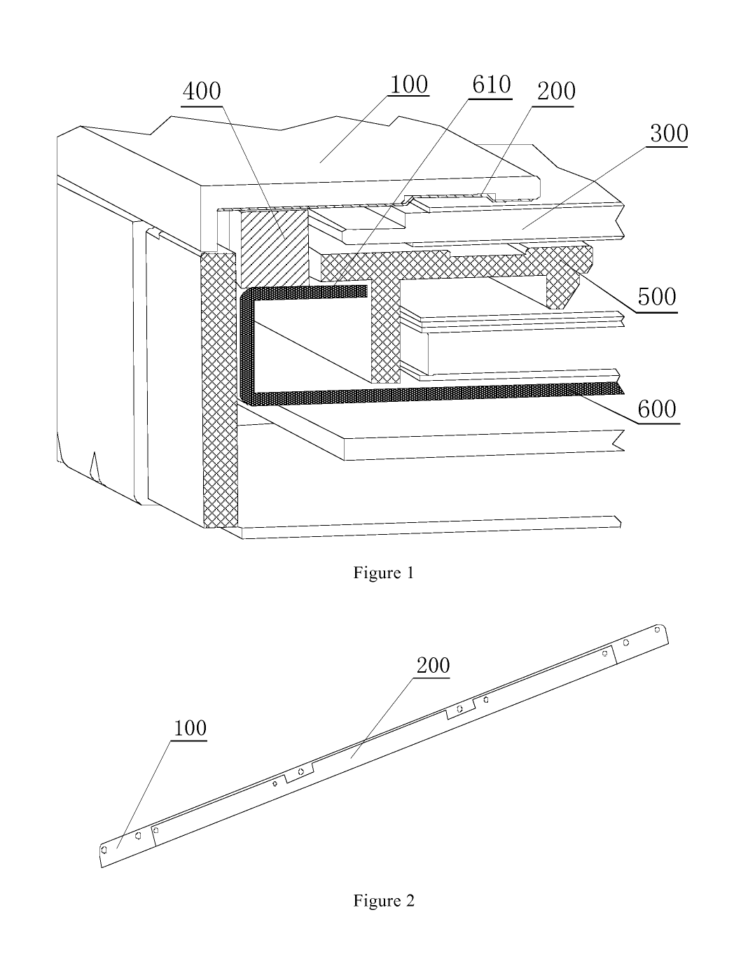

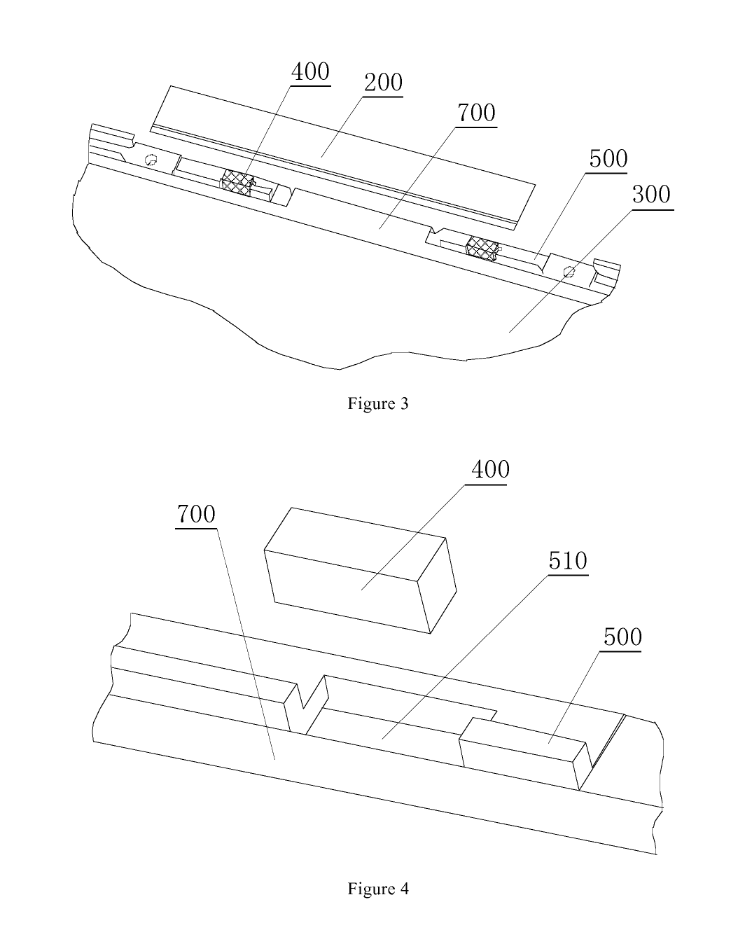

As shown in FIGS. 1-4, an LCD device comprises a front frame 100, a backplane 600, and an LCD panel 300 which are mutually matched and fixed in sequence from outside to inside; the front frame 100 is made of insulation material such as plastic material, etc., and the surface of the front frame 100 is covered with a layer of metal film 200 (such as aluminum foil, copper foil, etc. which are conducting material), to form a conducting film; the backplane 600 is made of conducting material such as metal, etc., and a conducting component(s) is connected between the conducting film of the front frame 100 and the backplane 600. The conducting film can cover the whole surface of the front frame 100, and can only cover one side of the front frame 100 facing the LCD panel 300. Rightly covering one side facing the LCD panel 300 with the conducting film can further reduce the cost.

Further, the conducting component can be a conducting spacer 400 made of flexible material; one end of the conducting spacer 400 is butted with the front frame 100, and the other end is connected with the backplane 600. Flexible material has certain elasticity; thus, the thickness of the conducting spacer 400 can be slightly more than the distance between the front frame 100 and the backplane 600; therefore, the conducting spacer 400 is extruded during assembly, and then is in close contact with the front frame 100 and the backplane 600 to achieve reliable electrical connection between the front frame 100 and the backplane 600. Because of having the function of bearing, preferably, the conducting spacers 400 are symmetrically distributed at equal distance, thereby favoring average stress, and increasing the bearing capacity.

For an LCD device with a rubber frame 500, because the rubber frame 500 is arranged across the front frame and the backplane, one side of the rubber frame 500 facing the front frame is provided with a through hole(s) 510, the conducting component penetrates through the through hole 510 and then is respectively connected with the conducting film of the front frame and the backplane, the COF 700 of the LCD panel is inserted into the rubber frame 500 to be fixed, and the earth terminal of the COF 700 is in contact with the conducting film; therefore, the distance between the conducting component connecting with the front frame and the backplane is minimized, thereby favoring simplification of design and assembly, and reducing the material cost of conducting components.

To further shorten the distance between the front frame 100 and the backplane 600, the backplane 600 is bent at one end corresponding to the conducting component to form a connecting surface 610 in the position near the through hole 510, and the conducting component penetrates through the through hole 510 and then is respectively connected with the front frame 100 and the connecting surface 610 of the backplane 600. Optionally, the connecting surface 610 formed by bending the backplane penetrates through the through hole 510, and then is connected with the conducting component.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. An LCD device, comprising: a front frame, a rubber frame, and a backplane which are mutually matched and fixed in sequence from outside to inside; wherein an LCD panel is clamped between said front frame and said rubber frame, said front frame is made of insulation material, and the surface of said front frame is provided with a conducting film; said backplane is made of conducting material, a conducting component(s) is connected between said conducting film and said backplane, and said conducting film is electrically connected with said backplane by said conducting component; only one side of said front frame facing said LCD panel is provided with said conducting film; said conducting component is a conducting spacer made of flexible material, one end of said conducting spacer is butted with said front frame, and the other end is butted with said backplane; said LCD device comprises a rubber frame arranged between said front frame and said backplane; one side of the rubber frame facing said front frame is provided with a through hole(s), said backplane is bent at one end corresponding to said conducting component to form a connecting surface near said through hole, and the connecting surface of said backplane penetrates through said through hole and then is connected with said conducting component; said conducting components are symmetrically distributed; said conducting film is a metal film; and said insulation material is plastic material.

2. An LCD device, comprising: a front frame, a rubber frame, and a backplane which are mutually matched and fixed in sequence from outside to inside; wherein an LCD panel is clamped between said front frame and said rubber frame, said front frame is made of insulation material, and the surface of said front frame is provided with a conducting film; said backplane is made of conducting material, a conducting component(s) is connected between said conducting film and said backplane, and said conducting film is electrically connected with said backplane by said conducting component.

3. The LCD device of claim 2, wherein only one side of said front frame facing said LCD panel is provided with said conducting film.

4. The LCD device of claim 2, wherein said conducting component is a conducting spacer made of flexible material, one end of said conducting spacer is butted with said front frame, and the other end is butted with said backplane.

5. The LCD device of claim 2, wherein said LCD device comprises a rubber frame arranged between said front frame and said backplane; one side of said rubber frame facing said front frame is provided with a through hole(s), and said conducting component penetrates through said through hole and then is respectively connected with said front frame and said backplane.

6. The LCD device of claim 5, wherein said backplane is bent at one end corresponding to said conducting component to form a connecting surface in the position near said through hole, and said conducting component penetrates through said through hole and then is respectively connected with the said front frame and the connecting surface of said backplane.

7. The LCD device of claim 2, wherein said LCD device comprises a rubber frame arranged between said front frame and said backplane; one side of said rubber frame facing said front frame is provided with a through hole(s), said backplane is bent at one end corresponding to said conducting component to form a connecting surface in the position near said through hole, and the connecting surface of said backplane penetrates through said through hole and then is connected with said conducting component.

8. The LCD device of claim 2, wherein said conducting components are symmetrically distributed.

9. The LCD device of claim 2, wherein said conducting film is of a metal film.

10. The LCD device of claim 2, wherein said insulation material is of a plastic material.
